(19) United States
(12) Patent Application Publication
(10) Pub. No.: US 2011/0280106 A1
(43) Pub. Date: Nov. 17, 2011

(54) ULTRASONIC SENSOR AND METHOD FOR OPERATING AN ULTRASONIC SENSOR

(76) Inventor: Martin Reiche, Weil Der Stadt (DE)

(21) Appl. No.: 13/061,913

(22) PCT Filed: Aug. 6, 2009
(86) PCT No.: PCT/EP2009/060231

§ 371 Date: May 9, 2011

(30) Foreign Application Priority Data
Sep. 9, 2008 (DE) 102008041894.3

(51) Int. Cl. G01S 7/526

(52) U.S. Cl. 367/100

(57) ABSTRACT

The ultrasonic sensor having a switchable receive filter has a first bandwidth for a near measuring range of the ultrasonic sensor, and a second bandwidth for a distant measuring range of the ultrasonic sensor, the first bandwidth being greater than the second bandwidth.

### BACKGROUND INFORMATION

Ultrasonic sensors have a receive filter, which suppresses interference signals. For system-related reasons, the receive filter leads to distortion of signals, which restricts the selectivity of a range determination.

From German Patent No. DE 34 11 135, azimuth-adaptable, phase-controlled sonar is already known.

### SUMMARY OF THE INVENTION

The method according to the present invention for operating an ultrasonic sensor encompasses the following steps: Switching a receive filter to a first bandwidth for detecting ultrasonic signals reflected at near objects, and switching the receive filter to a second bandwidth for detecting ultrasonic signals reflected at distant objects, the first bandwidth being greater than the second bandwidth.

A high-resolution range determination of near objects is achievable by lower distortion of the signals due to the greater bandwidth of the receive filter. This is important for parking aids, in particular.

The ultrasonic sensor having the switchable receive filter according to the present invention has a first bandwidth for a near measuring range of the ultrasonic sensor, and a second bandwidth for a distant measuring range of the ultrasonic sensor, the first bandwidth being greater than the second bandwidth.

### BRIEF DESCRIPTION OF THE DRAWINGS

FIG. 1 shows one specific development of an ultrasonic sensor.

FIG. 2 shows a flow chart of a method for operating an ultrasonic transducer.

### DETAILED DESCRIPTION

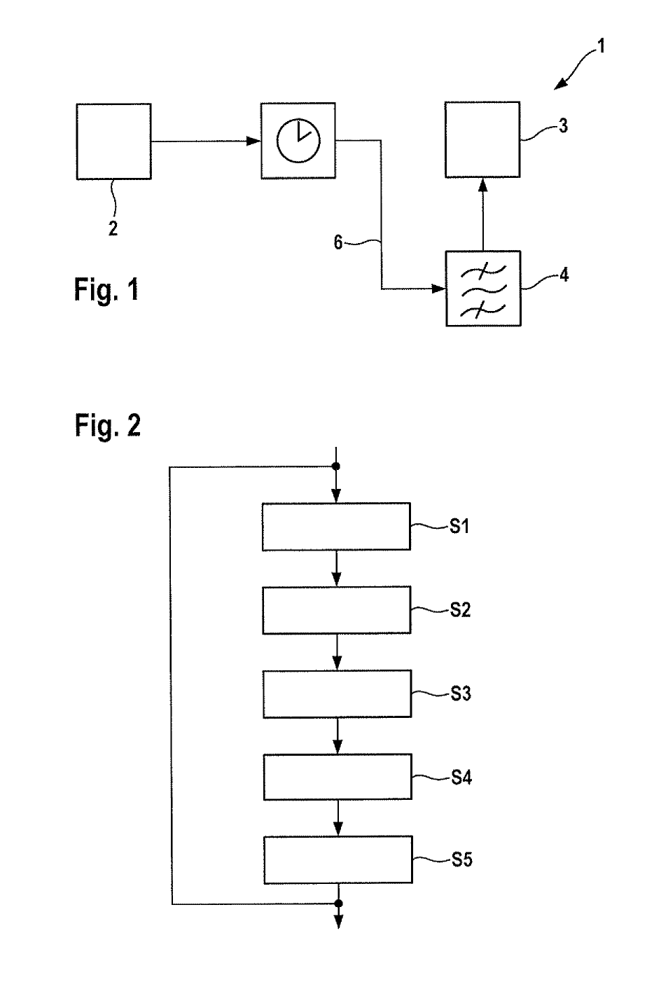

FIG. 1 shows a block diagram of an ultrasonic transducer 1. Ultrasonic transducer 1 has a transmitting device 2 including an ultrasonic transducer which is able to generate ultrasonic pulses. The ultrasonic pulses may have a duration in the range of 100 μs to 500 μs, such as 300 μs. The carrier frequency may lie within a range of 25 kHz to 100 kHz such as 50 kHz, for instance.

The ultrasonic pulses are reflected at objects. The reflected components are detected by a receiving device 3, which then uses the same ultrasonic transducer as the transmitting device 2.

The reflected components have a signal strength that is damped by more than 100 dB compared to the transmitted ultrasonic pulses. For this reason a band-pass filter is post-connected to receiving device 3, as receive filter 4, which is used for masking interference signals from other signal sources outside the useful band of the receive signal. The interference sources may be the motor, the spark plugs, or other ultrasonic transmitters. Furthermore, it must be taken into account that the transmission excitation signal has dropped to a level that is less than that of receive signals to be expected, e.g., by 100 dB.

The bandwidth of receive filter 4 is set up such that a narrow bandwidth selection of signals is achieved for distant objects, if possible. A bandwidth in the range from 5 kHz to 10 kHz, such as 8 kHz, for example, is suitable for this purpose. It is assumed that the transmission excitation signal has decayed by 100 dB and the ultrasonic transducer has already stopped oscillating by the time echoes arrive.

Ultrasonic sensor 1 provides for a switchover of the bandwidth for the detection of close objects. The near range may include objects within a radius of 30 cm, for example. Typically located within the near range are objects that are relevant when parking a motor vehicle. A greater bandwidth of receive filter 4 leads to lower phase distortions of the signals.

This also reduces the distortion of the phase of the decay signal. Pulsations of the decay signal as a result of the non-linear phase response of receive filter 4 are reduced. Furthermore, a dispersion of the signal and a resulting broadening of the signal are reduced. The bandwidth may be adjusted within the range from 10 kHz to 30 kHz, such as 20 kHz, for example.

Receive filter 4 may be made up of two discrete filter stages, between which a switchover is possible. As an alternative, receive filter 4 is made up of a digital filter whose taps are switched over during operation.

The switchover between a first bandwidth for measurements in the near range and a second bandwidth for measurements in the distant range may be accomplished by a timer 5. The method is shown as a flow chart in FIG. 2.

Prior to emitting an ultrasonic pulse, the bandwidth of the receive filter is set to a large bandwidth (S1). The receiving stage thus is set up to evaluate reflected signals from the near environment. Transmitting device 2 then emits an ultrasonic pulse (S2). When the ultrasonic pulse is emitted, timer 5 is reset or started (S3). Following a predefined time period, timer 5 outputs a trigger signal 6 to receive filter 4 (S4). This causes receive filter 4 to switch to a smaller bandwidth (S5).

Within the predefined time, the ultrasonic sensor is thus set up for near-range operation, and subsequently for distant-range operation. The predefined time specifies the distance at which the signals from objects are still received using the first setting of the band path. At an exemplary time of 6 ms and assuming a sonic velocity of 340 m/s, reflections of all objects within a radius of 1 m are detected with slight frequency filtering and slight distortion of the signals. For more remote objects a distortion of the signals is tolerated in exchange for an improved signal-to-noise ratio relative to interferers outside the signal's useful band. This tolerated distortion has a negligible effect on the radial selectivity, i.e., the ability to differentiate among target reflections. A radial selectivity describes the radial minimum distance required for two reflections having the same maximum level in order for the level to drop by at least 50% of the maximum level between the maxima of the reflections.

A further development uses more than two different settings of the receive filter. For example, the bandwidth of the receive filter may be reduced continually starting at the time when an ultrasonic pulse is emitted.

A further development increases the pulse duration of an ultrasonic pulse for the detection of objects at a great distance. In parallel, the bandwidth of receive filter 4 is reduced. For example, the pulse duration may be increased to 1 ms and the bandwidth reduced to 3 kHz.

1-7. (canceled)

8. An ultrasonic sensor comprising:
a switchable receive filter, which has a first bandwidth for a near measuring range of the ultrasonic sensor, and a second bandwidth for a distant measuring range of the ultrasonic sensor, the first bandwidth being greater than the second bandwidth.

9. The ultrasonic sensor according to claim 8, wherein the receive filter is a band-pass filter.

10. The ultrasonic sensor according to claim 8, further comprising a timer to switch the receive filter from the first bandwidth to the second bandwidth following a predefined time period after an emission of an ultrasonic pulse.

11. The ultrasonic sensor according to claim 8, wherein the first bandwidth is 20 kHz and the second bandwidth is 8 kHz.

12. A method for operating an ultrasonic sensor, comprising:
switching a receive filter to a first bandwidth for detecting ultrasonic signals reflected at near objects; and
switching the receive filter to a second bandwidth for detecting ultrasonic signals reflected at distant objects, the first bandwidth being greater than the second bandwidth.

13. The method according to claim 12, wherein, prior to emitting an ultrasonic pulse, the receive filter is switched to the first bandwidth, the ultrasonic pulse is emitted, and the receive filter is switched to the second bandwidth following a predefined time period after the emission of the ultrasonic pulse.

14. The method according to claim 12, further comprising:
emitting an ultrasonic pulse having a first duration for detecting ultrasonic signals reflected at near objects; and
emitting an ultrasonic pulse having a second duration for detecting ultrasonic signals reflected at distant objects, the first duration being shorter than the second duration.
